(19) United States
(12) Patent Application Publication
(10) Pub. No.: US 2011/0201425 A1
(43) Pub. Date: Aug. 18, 2011

(54) GAME MACHINE AND GAME PROGRAM

(75) Inventor: Tahei Katagai, Tokyo (JP)

(73) Assignee: KONAMI DIGITAL ENTERTAINMENT CO., LTD., Tokyo (JP)

(21) Appl. No.: 13/124,025

(22) PCT Filed: Nov. 12, 2009
(86) PCT No.: PCT/JP2009/069285

§ 371 Date: Apr. 13, 2011

(30) Foreign Application Priority Data
Dec. 25, 2008 (JP) 2008330550

(51) Int. Cl. G06F 17/00

(52) U.S. Cl. 463/31; 463/43

(57) ABSTRACT

There is provided a game machine which provides, while indicating operation timings to a player based on an auditory stimulation by a tune being reproduced, an environment which helps the player feel easy.

The game machine G generates display rows SR by allotting each of words W obtained by dividing lyrics of a tune to any one of display rows such that the word to be sung relatively earlier is positioned relatively forward. The game machine G comprises the display control portion 14 and the operation evaluation portion 14b. The display control portion 14 displays the generated display rows SR in the game image GI, and with the progress of reproducing the tune, a display of each display row SR is updated sequentially such that, in each display row SR, the word W to be sung first is displayed at the top of the display row SR. The operation evaluation portion 14b evaluates the operation by the player based on the timing in the tune of the moment when an input operation by the player has been performed and the timing which is correlated to the word of operation object.

### TECHNICAL FIELD

The present invention relates to a game machine and a game program which makes a player operate based on a tune being reproduced.

### BACKGROUND ART

As a game machine which reproduces a predetermined tune and makes a player operate based on the reproduced tune, for example, there is well known a dance game machine which indicates a player an operation timing by visual stimulation and evaluates the operation by the player (for example, see the patent literature 1).

### CITATION LIST

### Patent Literature

PTL 1:JP-B-3003851

### SUMMARY OF INVENTION

### Problem to be Solved by Invention

Moreover, there is also proposed a game machine which indicates the player operation timings based on auditory stimulation of the reproduced tune, but it is difficult to predict a next operation only by the auditory stimulation. Especially, it is hard to provide a good play-environment to a player who plays for the first time and a player who enjoys the play itself rather than a score.

### Means for Solving the Problem

The present invention solves the above problem by the following means. To make it easy to comprehend the present invention, reference numbers in the attached drawings are provided in parentheses, but the present invention is not limited to an embodiment shown by the drawings.

The first game machine as the first aspect of the game machine of the present invention solves the above problem by being configured such that a game machine comprising: a display portion which displays a game image; a sound output portion which reproduces and outputs a predetermined tune; an operation input portion which accepts an input operation by a player; a display control portion which arranges and displays in the game image, a plurality of letter strings in such a way that a plurality of letter-string lines are formed, the plurality of letter strings being obtained by dividing at least one part of lyrics of the tune; an operation object specifying portion which specifies the letter string of operation object within the plurality of letter strings; and an operation evaluation portion which evaluates the operation by the player to the letter string of operation object, wherein the game machine further comprises a game data storage portion which stores game data where each of the plurality of letter strings is correlated to a timing in the tune for the letter string to be sung, the display control portion comprises: a letter-string line generating portion which generates the plurality of letter-string lines by allotting each of the letter strings to any one of the letter-string lines in such a way that, in each of the letter-string line, the letter string to be sung relatively early is positioned relatively forward; and a letter-string line display control portion which displays in the game image, the plurality of letter-string lines generated, and updates sequentially a display of each of the letter-string lines with a progress of the tune being reproduced by the sound output portion, such that, for each letter-string line, the letter string to be sung first in the letter-string line is displayed at a top of the letter-string line, the operation object specifying portion sequentially specifies, each time when a timing for the word to be sung stored in the game data comes in the progress of the tune being reproduced, the letter string correlated to the timing as the operation object, and the operation evaluation portion evaluates the operation by the player based on a timing in the tune of a moment when the input operation is performed to the operation input portion by the player and the timing to be sung correlated to the letter string which has been specified by the operation object specifying portion.

According to the first game machine of the present invention, by the operation object specifying portion, with the progress of reproducing the tune, the letter string to be sung is sequentially specified as the letter string of operation object, and by the operation evaluation portion, the operation by the player is evaluated based on the timing in the tune of a moment when an input operation has been performed by the player to the letter string of operation object and the timing that the letter string of operation object should be sung. Accordingly, it is possible to provide a game which makes a player perform an input operation to a letter string being sung, and evaluates the accuracy of the timing of the input operation. Additionally, in the present invention, by the letter-string line generating portion, each of the letter strings is allotted to at least one letter-string line in an order to be sung, and by the letter-string line display control portion, with the progress of reproducing the tune, a display in each letter-string line is controlled such that the letter string which should be sung first in the letter-string line is displayed at the top of the letter-string line sequentially. Accordingly, any one of the letter strings each of which is being displayed at the top of the corresponding letter-string line is always the letter string of operation object. Since the letter strings in each of the letter-string lines which are displayed in the game image are arranged in an order to be sung, it is possible for a player to recognize visually subsequent letter strings. Thereby, it is possible to make a player foresee the lyrics to be next sung, and thereby, it is possible to provide an environment which helps the player feel easy.

“A timing for the letter string to be sung” in the game data may be a signal which indicates that timing when such a signal is set in a tune data to be reproduced, or may be an elapsed time from the start moment of reproduction of the tune. The timing may be any timing before the end of singing the string letter. The way that the letter-string line generating portion generates the letter-string line includes a case that each time the letter-string lines are generated, it is determined which line each word is allotted to, and a case that it is determined in the game data in advance which line each word is allotted to, and the letter-string lines are generated referring to the game data. The operation input portion may be an area of the game image which accepts a touch operation, and may be at least one operation member which accepts the input operation.

The letter-string line display control portion may display a predetermined number of letter strings in an order that the letter strings are arranged in each letter-string line and may display on one criterion line in the game image, the letter strings each of which is displayed at the top of corresponding letter-string line. Thereby, each of the letter-string lines having the same length is displayed in the game image in such a way that the tops of the lines are positioned on the criterion line. Since any one of the letter strings displayed on the criterion line of the game image is always the letter string to be song, that is, the letter string of operation object, a player can concentrate his/her mind only on the letter strings on the criterion line. Thereby, it is possible to provide to a player, an environment which helps the player feel easier.

The operation input portion may have a line operation input portion provided for each letter-string line, and the operation evaluation portion, when the input operation has been performed to the line operation input portion corresponding to the letter string of the operation object, may evaluate the input operation. For example, in a case that the operation input portion is a predetermined area, each of the line operation input portions is a part of the operation input portion, and in a case that the operation input portion is composed of plural operation members, each of the line operation input portions is a part of the operation members. Accordingly, since a valid range for the input operation is made narrower, it is possible to heighten a difficulty level of the game.

The operation input portion may accept the input operation by a touch panel sensor which is unified to the display portion, and the line operation input portion may be an area corresponding to each letter-string lines in the display portion. Thereby, it is possible to provide a game where a player made to perform a touch operation on the game image where the letter-string lines are displayed, and the touch operation is recognized as the input operation.

The second game machine as the second aspect of the game machine of the present invention solves the above problem by being configured such that a game machine comprising: a display portion which displays a game image; a sound output portion which reproduces and outputs a predetermined tune; an operation input portion which accepts an input operation by a player; a display control portion which arranges and displays in the game image, a plurality of letter strings in such a way that one letter-string line is formed, the plurality of letter strings being obtained by dividing at least one part of lyrics of the tune; an operation object specifying portion which specifies the letter string of operation objet within the plurality of letter strings; and an operation evaluation portion which evaluates the operation by the player to the letter string of operation object, wherein the game machine further comprises a game data storage portion which stores game data where each of the plurality of letter strings is correlated to a timing in the tune for the letter string to be sung, the display control portion comprises: a letter-string line generating portion which generates the plurality of letter-string line by arranging each of the string letters in an order for the string letter to be sung; and a letter-string line display control portion which displays in the game image, the letter-string line generated, and updates sequentially a display of each of the letter-string lines with a progress of the tune being reproduced by the sound output portion, such that the letter string to be sung is displayed sequentially at a top of the letter-string line, the operation object specifying portion sequentially specifies, each time when a timing for the word to be sung stored in the game data comes in the progress of the tune being reproduced, the letter string correlated to the timing as the operation object, and the operation evaluation portion evaluates the operation by the player based on a timing in the tune of the moment when the input operation is performed to the operation input portion by the player and the timing to be sung correlated to the letter string which has been specified by the operation object specifying portion.

Also in the second game machine of the present invention, by the operation object specifying portion, with the progress of reproducing the tune, the letter string to be sung is specified as the letter string of operation object sequentially. By the operation evaluation portion, the operation by the player is evaluated based on a timing in the tune of a moment when the input operation has been performed by the player to the letter string to be sung and a timing that the letter string of operation object should be sung. Accordingly, it is possible to provide a game which makes a player perform an input operation to the letter string being sung, and evaluates the accuracy of the timing of the input operation. Particularly, in the present invention, by the letter-string line generating portion, the plural letter-string lines are arranged in an order to be sung such that one letter-string line is generated, and by the letter-string line display control portion, a display in the game image is controlled such that, with the progress of reproducing the tune, the letter-string to be sung in the letter-string line is displayed at the top of the letter-string line sequentially. Accordingly, the letter string being displayed at the top of the letter-string line is always the letter string of operation object. Moreover, the plural letter strings composing the letter-string line are arranged and displayed in an order to be sung, it is possible for a player to recognize visually the subsequent letter strings. Thereby, it is possible to make the player foresee the lyrics to be sung next, and to provide an environment which helps the player feel easy.

“A timing for the letter string to be sung”, the way that the letter-string line generating portion generates the letter-string line, and the concept of the operation input portion are similar to those in a case of the first game machine. Moreover, in the second game machine, the letter-string line display control portion may display a predetermined number of letter strings in an order that the letter strings are arranged in the letter-string line and may display on one criterion line in the game image, the letter string which is displayed at the top of the letter-string line.

The string-letter line display control portion may remove the letter string of operation object from the letter-string line, when the input operation is performed to the letter string of operation object, and in the letter-string line, may display from the top thereof, the predetermined number of string letters following the letter string of operation object. Thereby, for example, it is possible to distinguish visually between the letter string to which the input operation has been performed and the letter string waiting the input operation in a display row. As the way that the letter string is removed from the letter-string line, a case that the letter string disappears from the game image and a case that the letter string is separated from the letter-string line and remains on the game image are included.

The letter-string line display control portion may remove the letter string of operation object from the letter-string line by separating the letter string from the letter-string line, the operation evaluation portion may change, depending on the evaluation to the player, a display mode of the letter string of operation object which has been separated from the letter string line. Thereby, it is possible to inform visually and immediately, the player of the evaluation of the operation performed to each letter string.

Specifically, for example, the operation evaluation portion may display the letter string separated in the display mode depending on a disparity amount between the timing to be sung correlated to the letter string of operation object and the timing in the tune of a moment when the input operation has been performed.

Each of a plurality of constant-velocity signs and a timing in the tune of a moment when the constant-velocity sign should reach a predetermined operation position in the game image are correlated to each other and may be further stored in the game data, the display control portion may further comprise a constant-velocity sign control portion which makes the constant-velocity sign appear at a predetermined appearance point in the game image and controls a move of the constant-velocity sign such that the constant-velocity sign moves in the game image at a predetermined velocity to reach the predetermined operation position at the corresponding timing in the tune, and the operation evaluation portion may evaluate the operation by the player based on the timing in the tune of a moment when the input operation has been performed to the constant-velocity sign and the timing in the tune correlated to the constant-velocity sign.

Thereby, for a part where there are no lyrics, for example, an interlude part, it is possible to provide a game where the constant-velocity sign is displayed in the game image. In the part where there are no lyrics like the interlude part, no operation to letter strings is required to the player. It could make the player bored. However, since the game using the constant-velocity sign is provided, it is possible to prevent the player from being bored.

When a particular sign to require a particular operation and a timing in the tune for the particular sign are correlated to each other following the letter string in the game data, the operation evaluation portion may evaluate the particular operation based on a timing in the tune of a moment when the particular operation has been performed and a timing in the tune correlated to the particular sign, and may determine an evaluation for the letter string by using the evaluation for the operation to the letter string by the player and the evaluation for the particular operation. Thereby, for example, also for the particular sound following the sound of letter string, such as a prolonged-sound and a vibrato, it is possible to require a player and evaluate an operation.

The game data storage portion may further stores tune characteristics information, in which each of a plurality of components and a start timing in the tune that the component is started are correlated to each other, the components being obtained by dividing, based on sound characteristics, tune data of the tune corresponding to the game data, the game machine may further comprises: a using tune analysis portion which sound analyzes using tune data which is tune data of a tune to be used, and obtains a start timing of each of the components for the using tune data, and a data adjustment portion which generates adjusted game data by adjusting the timings to be sung correlated in the game data to the letter strings included in each of the components, based on the start timing of each of the components in the tune characteristics information and the start timing of each of the components in the using tune data, and the operation evaluation portion may evaluate the operation by the player based on the adjusted game data.

Thereby, even in a case that a tune data different from a tune data expected for the game data is used, and a case that, though the tune data to be used is the same as the tune data expected, because of the encode, the timings that the lyrics are sung by the tune data are not coincident with each other, by sound-analyzing the tune data to be used, the tune data to be used is adjusted to generate the adjusted game data, and the operation is evaluated based on the adjusted game data. Accordingly, it is possible to treat as the tune of the present invention, even such a tune data that the lyrics are sung at timings different from timings in the tune data expected for the game data. Accordingly, for example, without obtaining the tune data expected for the game data, the player can always use the tune data which he/she has as the tune data of the present invention.

In the second game machine, the tune may be a choral music which has plural parts, the game data storage portion may store the game data for each of the parts, in which each of the letter strings which are obtained by dividing the lyrics in the corresponding part and a timing for the letter string to be sung are correlated to each other, the letter-string line generating portion may generate the letter string line corresponding to each of the parts by arranging each letter string for each part in an order for the letter string to be sung, the letter-string line display control portion may update sequentially a display of the letter-string line corresponding to each of the parts, the operation object specifying portion, each time when the timing to be sung set in the game data for each part has come, may specify as the operation object, the at least one letter string correlated to the timing, and the operation evaluation portion may evaluate, with respect to each letter string specified as the operation object, the operation by the player based on the timing that the input operation has been performed and the timing to be sung.

Thereby, for the choral music having a plurality of parts, a letter-string line where letter strings are arranged for each part is displayed, and the operation object is specified sequentially in each letter-string line. The player is required to distinguish auditorily each of the parts and perform the input operation to the lyrics being sung. For example, there is a case that plural operation objects occur at the same time. Therefore, it is possible to provide a high level game.

Also, in the first and second game machines, the game data storage portion may store, with respect to the tune, besides the game data, constant-velocity game data in which each of a plurality of constant-velocity signs is correlated to a timing in the tune that the constant-velocity sign should reach a predetermined operation position in the game image, the display control portion may further comprise, besides the letter-string line generating portion and the letter-string line display control portion, a constant-velocity sign control portion which controls a move of the constant-velocity sign in such a way that the constant-velocity sign is made to appear at a predetermined appearance point in the game image when the tune is reproduced, and made to move in the game image at a predetermined velocity such that the constant-velocity sign reaches the predetermined operation portion at the timing in the tune correlated to the sign, and the operation evaluation portion may evaluate the operation by the player, besides the evaluation for the operation by the player to the letter string specified as the operation object, based on a timing in the tune of a moment when the input operation has been performed to the constant-velocity sign and the timing in the tune correlated to the sign.

If the timings that the constant-velocity sign reaches a predetermined operation position are set to meet the rhythm of a predetermined instrument which is being used in an accompaniment of a tune to be reproduced, it is possible to provide such a game which requires at the same time, both of the input operation to the timing for the lyrics being sung and the input operation to the timing of the rhythm of the instrument in the accompaniment.

The first game program as the first aspect of the game program of the present invention solves the above problem by being configured such that a game program which controls a computer of a game machine, the game machine comprising: a display portion which displays a game image; a sound output portion which reproduces and outputs a predetermined tune; an operation input portion which accepts an input operation by a player; a display control portion which arranges and displays in the game image, a plurality of letter strings in such a way that a plurality of letter-string lines are formed, the plurality of letter strings being obtained by dividing at least one part of lyrics of the tune; an operation object specifying portion which specifies the letter string of operation object within the plurality of letter strings; an operation evaluation portion which evaluates the operation by the player to the letter string of operation object; and a game data storage portion which stores game data where each of the plurality of letter strings is correlated to a timing in the tune for the letter string to be sung, wherein the game program controls the computer to function as the display control portion which comprises: a letter-string line generating portion which generates the plurality of letter-string lines by allotting each of the letter strings to any one of the letter-string lines in such a way that, in each of the letter-string line, the letter string to be sung relatively early is positioned relatively forward; and a letter-string line display control portion which displays in the game image, the plurality of letter-string lines generated, and updates sequentially a display of each of the letter-string lines with a progress of the tune being reproduced by the sound output portion, such that, for each letter-string line, the letter string to be sung first in the letter-string line is displayed at a top of the letter-string line, the operation object specify portion which sequentially specifies, each time when a timing for the word to be sung stored in the game data comes in the progress of the tune being reproduced, the letter string correlated to the timing as the operation object, and the operation evaluation portion which evaluates the operation by the player based on a timing in the tune of a moment when the input operation is performed to the operation input portion by the player and the timing to be sung correlated to the letter string which has been specified by the operation object specifying portion.

The second game program as the second aspect of the game program of the present invention solves the above problem by being configured such that a game program which controls a computer of a game machine, the game machine comprising: a display portion which displays a game image; a sound output portion which reproduces and outputs a predetermined tune; an operation input portion which accepts an input operation by a player; a display control portion which arranges and displays in the game image, a plurality of letter strings in such a way that one letter-string line is formed, the plurality of letter strings being obtained by dividing at least one part of lyrics of the tune; an operation object specifying portion which specifies the letter string of operation objet within the plurality of letter strings; an operation evaluation portion which evaluates the operation by the player to the letter string of operation object; and a game data storage portion which stores game data where each of the plurality of letter strings is correlated to a timing in the tune for the letter string to be sung, wherein the game program controls the computer to function as the display control portion which comprises: a letter-string line generating portion which generates the plurality of letter-string line by arranging each of the string letters in an order for the string letter to be sung; and a letter-string line display control portion which displays in the game image, the letter-string line generated, and updates sequentially a display of each of the letter-string lines with a progress of the tune being reproduced by the sound output portion, such that the letter string to be sung is displayed sequentially at a top of the letter-string line, the operation object specifying portion which sequentially specifies, each time when a timing for the word to be sung stored in the game data comes in the progress of the tune being reproduced, the letter string correlated to the timing as the operation object, and the operation evaluation portion which evaluates the operation by the player based on a timing in the tune of the moment when the input operation is performed to the operation input portion by the player and the timing to be sung correlated to the letter string which has been specified by the operation object specifying portion.

### Effects of the Invention

As mentioned above, according to the present invention, display rows SR are generated by allotting each of words W obtained by dividing lyrics of a tune to any one of display rows such that the word to be sung relatively earlier is positioned relatively forward. The display control portion and the operation evaluation portion are included. The display control portion displays the generated display rows SR in the game image GI, and with the progress of reproducing the tune, a display of each display row SR is updated sequentially such that, in each display row SR, the word W to be sung first is displayed at the top of the display row. The operation evaluation portion evaluates the operation by the player based on the timing in the tune of the moment when an input operation by the player has been performed and the timing which is correlated to the word of operation object. Thereby, it is possible to provide a game machine and the like which provides, while indicating operation timings to a player based on an auditory stimulation by a tune being reproduced, an environment which helps the player feel easy.

### BRIEF DESCRIPTION OF DRAWINGS

FIG. 1 A diagram shows an example of a game machine and a game image of the present invention.

FIG. 2 A diagram shows an example of display mode for a play result in a game executed in the game machine shown in FIG. 1.

FIG. 3 A diagram shows a game image of a game to be provided during an interlude in the game machine shown in FIG. 1.

FIG. 4 A diagram shows a schematic configuration of hardware of the game machine 1 shown in FIG. 1.

FIG. 5 A diagram shows an example of game data.

FIG. 6 A flowchart shows processes executed in a game process.

FIG. 7 A flowchart shows processes executed in a timing evaluation process.

FIG. 8 A flowchart shows processes executed in an interlude process.

FIG. 9 A flowchart shows processes executed in a safe process.

FIG. 10 A diagram shows a state that a tune data is sound analyzed.

FIG. 11 A diagram shows tune characteristics data of the tune sound analyzed.

FIG. 12 A flowchart shows processes executed in a data adjustment process.

FIG. 13 A diagram shows an example of game image in a case of two display rows.

FIG. 14 A diagram shows an example of game image in a case of one display row.

FIG. 15 A diagram shows another embodiment of game image.

FIG. 16 A diagram shows an accuracy mode and an inaccuracy mode in the game image shown in FIG. 15.

FIG. 17 A diagram shows a miss operation mode in the game image shown in FIG. 15.

FIG. 18A A diagram shows a state that a prolonged-sound sign is displayed in the game image in another embodiment.

FIG. 18B A diagram shows a state that the prolonged-sound sign shown in FIG. 18A passes through a process line.

FIG. 19 A diagram shows a state that a vibrato sign is displayed in the game image in another embodiment.

FIG. 20A A diagram shows a state that a bounce sign is displayed in another embodiment.

FIG. 20B A diagram shows the other embodiment for the bounce sign.

### EMBODIMENT FOR EXECUTING INVENTION

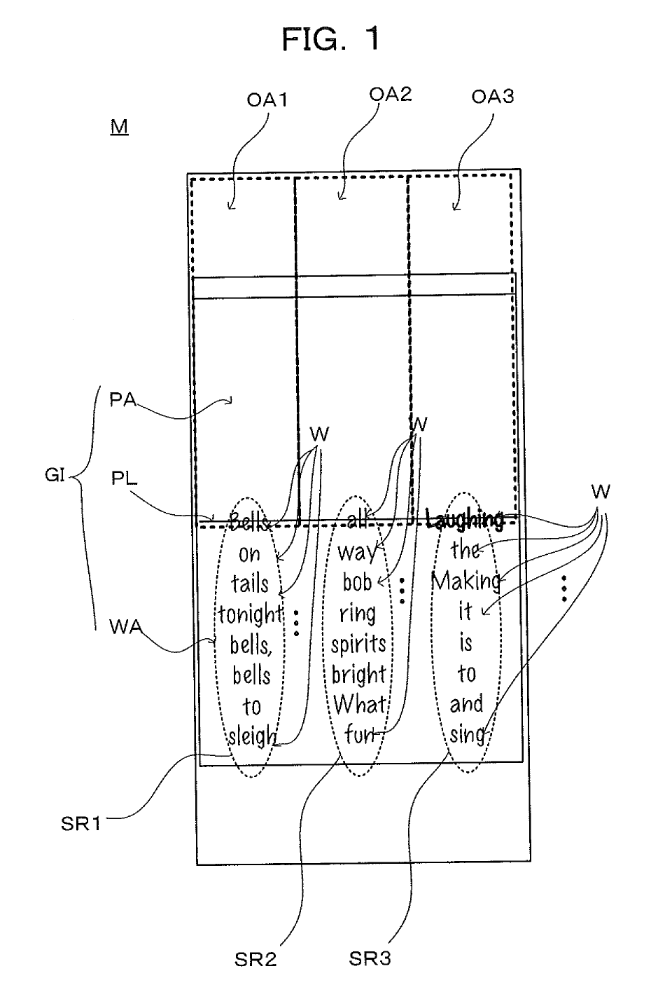

FIG. 1 shows an example of a game image GI which is displayed on a monitor M of a game machine G of the present invention. The game machine G of the present embodiment is preferably a portable-type game machine having a full-face screen as the monitor M. A touch panel sensor is integrally mounted to the monitor M. Thereby, when a touch operation is performed at a desired position on the monitor M by a player with his/her finger or pen, touch information indicating that the touch operation has been performed at the desired position is input to the game machine G. In the operations to be performed by the player and accepted by the touch panel sensor, there are also included a slide operation that his/her finger or pen is moved on the monitor M and an operation that his/her finger or a pen is held down for a while. Hereinafter, the touch operation, the slide operation and the operation of holding down are collectively called the input operation.

When the game starts, the game image GI is displayed on the monitor M. The game image GI comprises a process line PL shown at the center part of the game image GI, a word area WA which is an upper area than the process line PL, and a play result area PA which is a lower area than the process line PL. In the word area WA, three display rows SR1, SR2, SR3 as letter-string lines are arranged. Hereinafter, when it is not necessary to distinguish each of the display rows SR1 to SR3, each of them is called “the display row SR”. In each of the display rows SR, eight words W as a plurality of letter-strings are arranged in a vertical direction, the plurality of letter-strings which are obtained by dividing lyrics of a predetermined tune A. The lyrics of the present embodiment are English, and each word W is obtained by dividing the lyrics on a word basis in principal. With respect to each display row SR, the plurality of words W are arranged in such a way that the word W to be sung comparatively earlier is arranged comparatively forwarder (“upper” in the present embodiment), and the top words W are arranged in such a way that they are aligned on the process line PL as a criterion line.

In addition, the monitor M of the game machine G has operation areas OA1 to OA3 corresponding to the display rows SR1 to SR3 respectively. Hereinafter, when it is not necessary to distinguish each of the operation areas OA1 to OA3, each of them is called “the operation area OA”. At the game machine G, there is provided a music game where, when a tune A being reproduced, the word W being sung of the words W arranging on the process line PL is set as an operation object, a player is required to perform a touch operation to the operation area OA while the word being sung, and the timing when the touch operation was performed (hereinafter, this timing is called “the operation timing”) is evaluated.

When the touch operation is performed by a player to the word W being sung, that is, the word W as the operation object, or when no touch operation to the word W as the operation object is performed even if the word W as the operation object has been sung completely, the word Was the operation object is separated from the display row SR to move toward the play result area PA. In the display SR, each of the subsequent words W moves toward the direction of process line PL, that is, moves one step upward. At this moment, a new word W is displayed at the end of the display row SR, so that eight pieces of words W are always displayed in the display row SR. By updating sequentially the display of the display row SR in this way, with respect to each display row SR, the word W which should be sung first is always displayed at the top. Accordingly, the display row SR is designed such that the word W to be sung is waiting on the process line PL sequentially in each display row SR. The display of display row SR is updated repeatedly until the word W is run out. Hereinafter, in the present embodiment, “moving” not accompanied with a special note means “moving upward”.

In an example shown in FIG. 1, it will be described specifically how to display the display row SR. For example, in a case that the top word in the display row SR3, “Laughing”, has been sung, and the touch operation has been performed to the operation area OA, the word “Laughing” is separated from the display row SR3 to move to the play result area PA, and in the display row SR3, each of the subsequent words W after “the” one step moves. Thereby, “the” is arranged on the process line PL. In order to display eight pieces of the words W in the display row SR3, in a case that a word W exists after “sing” which is displayed at the end, the word W is displayed after “sing”. The word “Laughing” which has been separated from the display row SR3 moves in the play result area PA in a state different depending on the evaluation (the degree of accuracy) of operation timing.

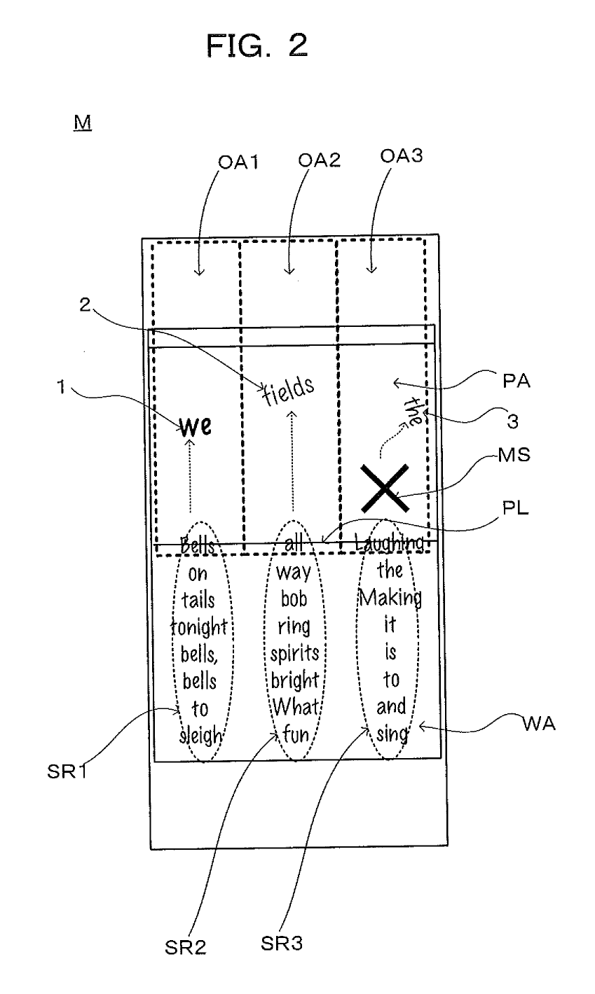

In a case that the operation timing is accurate, the corresponding word W is moved in the play result area PA in a accuracy mode, and in a case that the operation timing is inaccurate, the corresponding word W is moved in the play result area PA in an inaccuracy mode. In the present embodiment, as shown in FIG. 2, the accuracy mode 1 is represented as a bold letters like the word “We”, and the inaccuracy mode 2 is represented tilted letters like the word “fields”. As the degree of accuracy is lower, the tilt degree of the word W is bigger. Moreover, in the inaccuracy mode 2, the tilt to the left means that the operation timing was too early and the tilt to the right means the operation timing was too late. Hereinafter, the display mode including the accuracy mode 1 and the inaccuracy mode 2 in a case of performing the touch operation, is called “the clear display”. Additionally, the points to be obtained by the player are also designed so as to be different depending on the degree of accuracy.

On the other hand, in a case that, while the word W is being sung, there is no touch operation to the operation area OA corresponding to the word W, the state is determined as a miss operation to the word W, and the word W moves in the play result area PA in a miss operation mode. In the present embodiment, as the miss operation mode, a state is displayed that a miss operation symbol MS is displayed at the corresponding operation area OA for a moment, and after that, the word W as the operation object is blown off in an oblique direction. In the example shown in FIG. 2, the word “the” is represented in the miss operation mode 3.

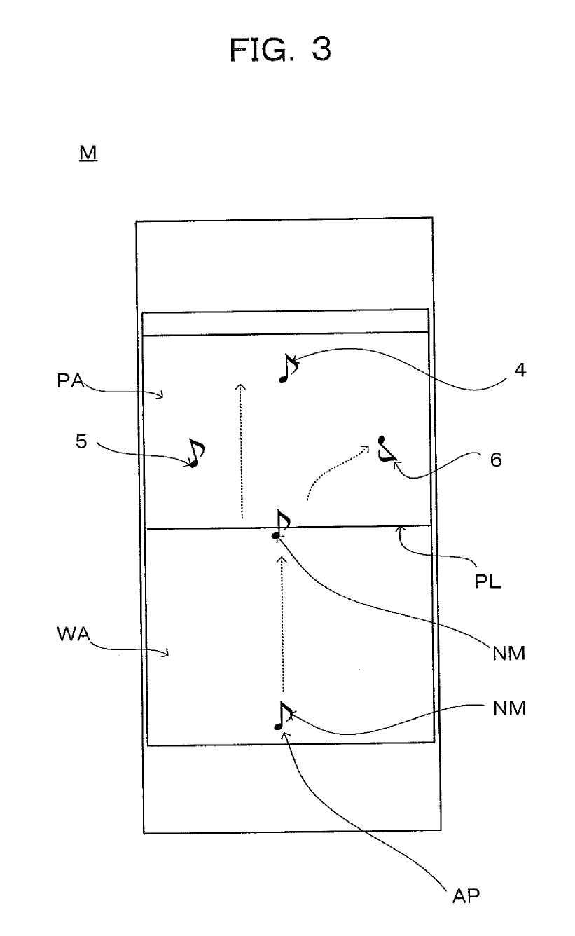

Moreover, in the present embodiment, in an interlude portion not having lyrics, there is provided an interlude game. In the interlude game, as shown in FIG. 3, a note mark NM, not the word W as a letter string is used. The note mark NM is displayed at an appearance point AP which is set at a bottom portion of the corresponding display row SR, and moves to a top portion of the game image GI at a predetermined speed. In the interlude game, at the moment when the moving note mark NM reaches the operation line PL, a player is required to perform the touch operation to the operation area OA corresponding to the note mark NM, and the evaluation is executed based on the operation timing. In the present embodiment, each of the plural note marks NM moves at the same speed. Hereinafter, the speed is called “the moving velocity”. Each of the note marks NM may be designed so as to move at different speed. It is preferable that the note marks NM are set suitably to the rhythm of a predetermined instrument in the interlude, such that a player performs the operation touch to the rhythm of the interlude.

Also in the interlude game, the note mark NM is displayed, in the play result area PA, in a mode different depending on the degree of accuracy of the operation timing. In a case that the operation timing is an ideal operation timing, that is, in a case that the touch operation is performed at the moment when the note mark NM is on the process line PL, as the accuracy mode 4 in the interlude game, for example, the note mark NM is moved upward as it is. In a case that there is a gap between the operation timing and the ideal operation timing, as the inaccuracy mode 5 in the interlude game, for example, the note mark tilted is moved. The degree of tilt is proportional to the amount of the gap. In the inaccuracy mode 5, the tilt to the left means the operation timing was too early, and the tilt to right means the operation timing was too late. Additionally, the points to be obtained by the player are also designed so as to be different depending on the degree of accuracy.

Moreover, in a case that, even if a predetermined time has elapsed after the note mark passes by the process line PL, the touch operation for the note mark NM was not performed, the state is determined as a miss operation to the note mark NM. When it is determined as the miss operation, the corresponding note mark NM is represented in the play result area PA in a miss operation mode 6. In the present embodiment, as the miss operation mode 6 in the interlude game, a state is displayed that the corresponding note mark NM is blown off in an oblique direction in the play result area PA.

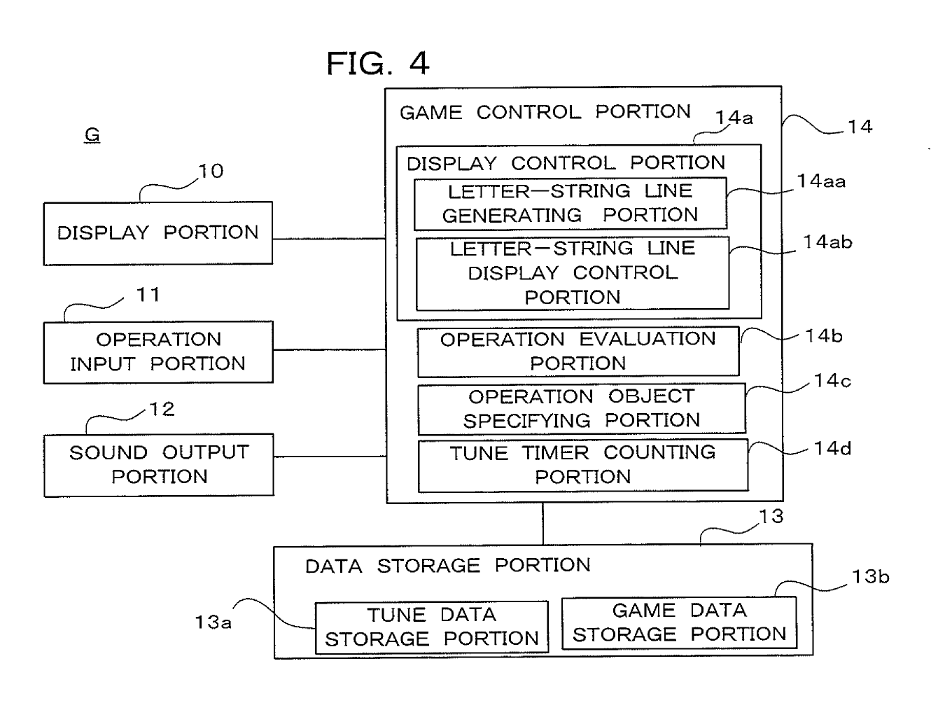

A specific configuration for realizing the above mentioned game in the game machine G will be described. First, a hard ware configuration of the game machine G will be described using FIG. 4. The game machine G comprises a display portion 10 as the monitor M, an operation input portion 11 having a touch panel sensor which is integrated with the monitor M, a sound output portion 12 which reproduces and outputs a tune, a data storage portion 13 which stores various kinds of data necessary for executing the game and a game program for realizing the present invention, and a game control portion 14 which controls operations of the portions 10 to 13 in the game machine G.

The operation input portion 11 accepts input operations by a player during the game, and records sequentially the timings of the input operations, as input operation data. The game control portion 14 has CPU and a memory area, such as RAM and ROM, necessary for the CPU's operations. When the game program stored in the data storage portion 13 is executed, the game control portion 14 functions mainly as a display control portion 14a, an operation evaluation portion 14b, an operation object specifying portion 14c, and a tune timer counting portion 14d. The tune timer counting portion 14d counts an elapsed time from the start moment of reproduction of the tune. The display control portion 14a further has a letter-string line generating portion 14aa, and a letter-string line display control portion 14ab. The function of each of the portions in the game control portion 14 will be described later.

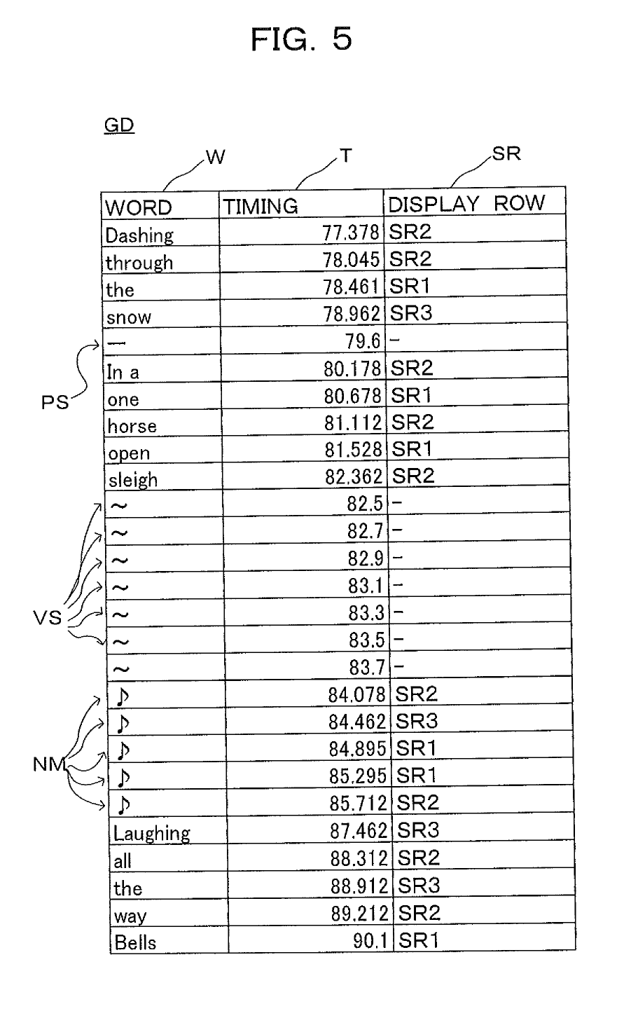

In the data storage portion 13, tune data storage portion 13a and game data storage portion 13b are included. In the tune data storage portion 13a, tune data of a tune to be reproduced by the sound output portion 12 is stored. In the game data storage portion 13b, the game data, where an aim timing T which is an ideal operation timings is set for each word W, is stored. The game data GD is prepared for each tune. For example, the game data GD for the tune A is shown in FIG. 5. In the game data GD, as shown in FIG. 5, the word W, the aim timing T, and the display row SR where the word W should be displayed are correlated to each other. The words W is set in an order that each word W should be sung. In the aim timing T, as the ideal operation timing for each word W, the timing when each word should be sung is set. The aim timing T in the present embodiment is indicated as an elapsed time from the start moment of reproduction.

In the game data GD in the present embodiment, the note marks NM to be displayed in the interlude game are set as the words W. Additionally, in the game data GD, a particular sign such as a prolonged-sound sign PS and a vibrato sign VS is also set as the word W. The particular sign is set following the word W corresponding to the particular sign. For example, the prolonged-sound sign PS set following the word “snow” requires to prolong the end portion of the word “snow”. Although the particular sign is not displayed in the display row SR, when an operation corresponding to each particular sign is performed by a player, the operation is evaluated. For example, the vibrato operation corresponding to the vibrato sign VS is the operation of making his/her finger or pen reciprocate in a vertical or horizontal direction in the operation area OA of the corresponding word W. In the game data GD, the aim timing T at the moment of each turn of the reciprocating movement is correlated to the particular sign.

The prolonged-sound operation corresponding to the prolonged-sound sign PS is an operation of holding down a finger or a pen on the operation area OA of the corresponding word W. In this embodiment, if the holding down is kept until the aim timing T, the operation is determined as the prolonged-sound operation. It is preferable that the word W constructed by a letter string is one word, but it is possible to set plural words as one piece of word W like “In a”. In this case, though plural words are included grammatically in the word W, the word W is treated as one piece of word W in the game. By setting plural words as one piece of word W, the number of touch operations to be required within a predetermined time is reduced. Thereby, the level of difficulty is made easy.

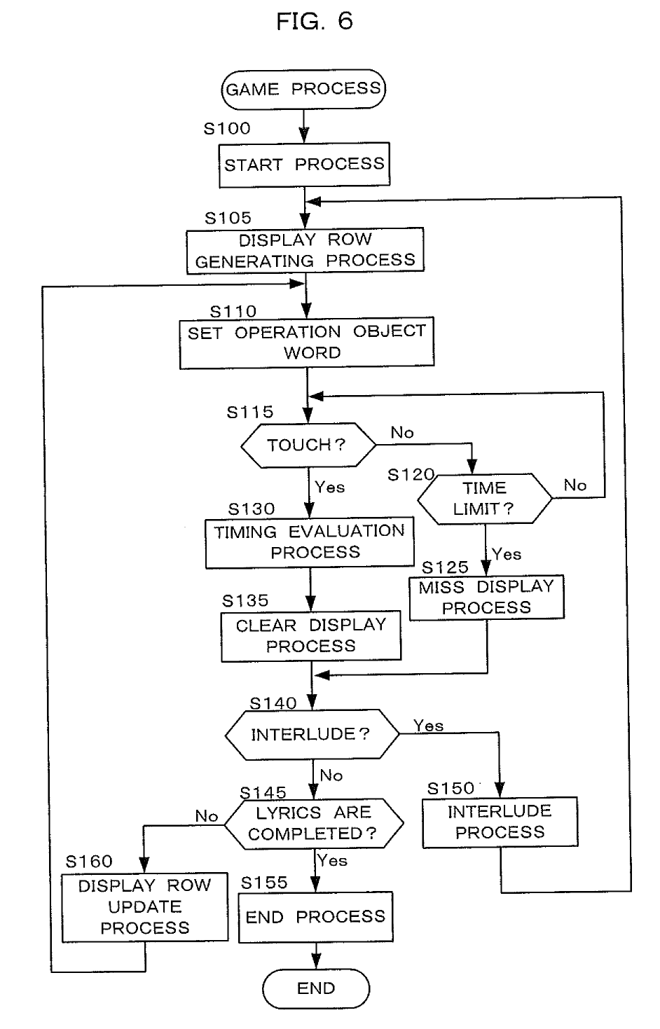

The game process will be described by following a flow chart shown in FIG. 6, the game process being executed by the game control portion 14 for executing the above mentioned game in the game machine G. The game process is executed after when, for example, a tune to be reproduced (a tune A in the present embodiment) is determined and a predetermined start operation is performed by a player. First, at step S100, a start process is executed. In the start process, referring to the tune data storage portion 13a and the game data storage portion 13b, the tune data of tune A to be reproduced and the game data GD corresponding to the tune A are specified, and the reproduction of tune A is started. At the same moment of starting the reproduction of tune A, the time-counting by the tune timer is started. Hereinafter, the tune timer is executed by the tune timer counting portion 14d.

Subsequently, the process goes to step S105 to execute a display row generating process. In the display row generating process, the game data GD is referred to display in the word area WA, eight pieces of words W for each display row SR1 to SR3. Thereby, the game control portion 14 functions as the letter-string line generating portion 14aa. In each of the display rows SR1 to SR3, the word W to be sung first is arranged on the process line PL as the top word of the corresponding display row SR. In the example shown in FIG. 5, the top word in the display row SR1 “the”, the top word in the display row SR2 “Dashing”, and the top word in the display row SR3 “snow” are arranged on the process line PL respectively. In the present embodiment, the words W except for letter strings, such as vibrato sign VS, prolonged-sound sign PS, and note mark NM, are not displayed in the display row SR.

After the display rows SR are displayed, at step S110, an operation object word is set. Thereby, the game control portion 14 functions as the operation object specifying portion 14c. The operation object word means the word W which is being sung in the tune A being reproduced out of the three words W which have been arranged on the process line PL. In the present embodiment, the first word in the lyrics “Dashing” is set as the operation object word at the moment of reproduction start. Next, at step S115, it is determined whether the touch operation has been performed by the player or not. When the touch operation has been performed in the operation area OA corresponding to the operation object word, it is determined that the touch operation has been performed and an affirmative determination is obtained. In the present embodiment, in a case that the touch operation has been performed in the operation area OA2 corresponding to the display row SR2 where the operation object word “Dashing” is being displayed, it is determined that the touch operation has been performed, and the process goes to step S130.

In a case that a negative determination is obtained at step S115, the process goes to step S120 to determine whether a time limit has come or not. The time limit means a limit timing when “Dashing” should be set as the operation object word, that is, a moment when “Dashing” has been sung completely. For example, in a case 0.1 seconds prior to the next word W to be sung is set as the time limit, at the moment when the time limit has come, it is determined that the time lime has come. When a negative determination is obtained at step S120, the process returns to step S115 to move into a state of waiting the touch operation. On the other hand, when an affirmative operation is obtained at step S120, the process goes to step S125 to execute a miss display process with respect to the operation object word, and after that, the process goes to step S140.

In the miss display process, for indicating that there has been no operation to the operation object word, the operation object word is displayed in the play result area PA in the miss operation mode 3 mentioned. In addition, in the game process, if a safe operation is performed by the player after the operation object word is displayed in the miss operation mode 3 before the process of step S160, the safe process is executed as an interrupt handling. The safe operation and the safe process will be described later.

When an affirmative determination is obtained at step S115, the process goes to step S130 to execute a timing evaluation process. In the timing evaluation process, the accuracy of operation timing is determined based on the operation timing of the touch operation by the player and the aim timing T set in the game data GD for the operation object word. The detail of the timing evaluation process will be described later. When the accuracy is determined based on the timing evaluation, a clear display process is executed in step 135. In the clear display process, the clear display is executed for the operation object word based on the timing evaluation determined in step S130.

As mentioned above description on the clear display, the operation object word is separated from the display row SR, and moves in the play result area PA in the accuracy mode 1 or the inaccuracy mode 2 depending on the accuracy of operation timing. In this embodiment, if the accuracy satisfies a predetermined criterion, the operation object word is displayed in the accuracy mode 1. If the accuracy does not satisfy the predetermined criterion, the operation object word is displayed in the inaccuracy mode 2. In the case of inaccuracy mode 2, the direction for tilting the operation object word is determined depending on whether the operation timing is earlier or later than the aim timing T. Additionally, in the clear display process, the points depending on the timing evaluation are added to the score of the player.

After the clear display process or the miss display process is executed for the operation object word, at step S140, it is determined whether the interlude of the tune A being reproduced starts or not. For determining whether the interlude starts or not, for example, the timing when the interlude should start, or the characteristic sound wave indicating the interlude start, may be set in advance for the tune A being reproduced. When an affirmative determination is obtained at step S140, the process goes to step S150 to execute an interlude process. In the interlude process, a process with respect to each of the note marks NM set in the game data GD, and, as mentioned above, the interlude game based on the note marks NM is executed. The details of the interlude process will be described later. When the interlude process is completed, the process returns to step S105, and by referring to the game data GD, the display row generating process for the lyrics after the interlude is executed. For example, the display rows SR can be generated identifying the words not yet used, by setting in the game data GD, a used-word flag to the word which has been used in the game.

When a negative determination is obtained at step S140, the process goes to step S145 to determine whether the lyrics are completed or not. For example, in a case that no word W to be displayed in the game image GI remain, it is determined that the lyrics are completed. When an affirmative determination is obtained at step S145, the process goes to step S155 to execute an end process, and after that, the game process is made to end. In the end process, after the lyrics are completed, for example, the reproduction of ending part is continued until the end of the tune A, and for example, the play result display is displayed on the monitor M. In addition, also in the ending part, a game similar to the interlude game may be provided.

When a negative determination is obtained at step S145, the process goes to step S160 to execute the display row update process. In the display row update process, a display with respect to the display row SR of the operation object word which was the object of the clear display process or the miss display process. Thereby, the game control portion 14 functions as the letter-string line display control portion 14ab. For example, in a case that the operation object word is the word “Laughing”, in the display row SR3 of the word “Laughing”, each of plural words W following the word “Laughing” moves one step upward. Thereby, “the”, which is the next word of “Laughing”, is arranged on the process line PL.

Additionally, with respect to the display row SR3, in a case that a word W following “sing” which is displayed at the end is set in the game data GD, the word W is displayed at the end of the display row SR3. In a case that the word W following the operation object word “Laughing” does not exist, the display row update process is skipped. After the display row update process, the process returns to step S110 to set as the operation object word, the word W to be sung next. In a case that the lyrics are “Laughing all the . . . ”, “all” which should be sung following “Laughing” is set as the operation object word.

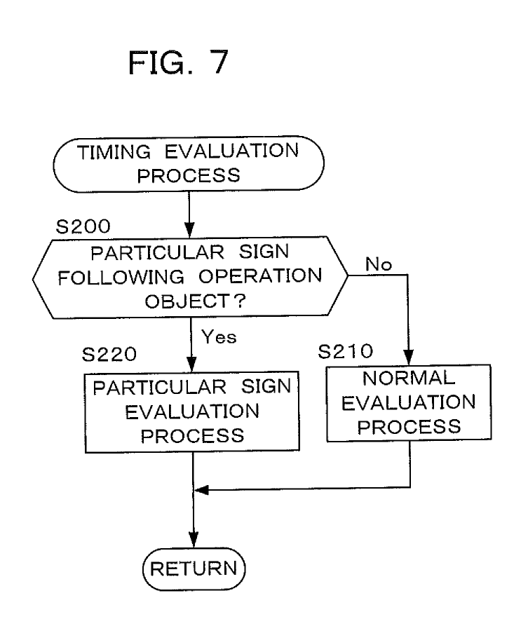

The timing evaluation process will be described by following a flow chart shown in FIG. 7. The timing evaluation process is executed by the game control portion 14 as the operation evaluation portion 14b. In the timing evaluation process, the operation timing is specified sequentially by input operation data which is recorded sequentially in response to the input operation by the operation input portion 11. First, at step S200, it is determined whether, in the game data GD, a particular sign such as a vibrato sign VS or a prolonged-sound sign PS is set following the operation object word. In a case that a negative determination is obtained at step S200, the process goes to step S210 to execute a normal evaluation process. In the normal evaluation process, the operation timing of only the operation object word is evaluated. In this embodiment, the smaller the disparity amount between the operation timing and the aim timing T is, the higher the accuracy is evaluated, and the bigger the disparity amount is, the lower the accuracy is evaluated. Additionally, it is also determined which the operation timing is earlier or later than the aim timing T. After the normal evaluation process is completed, the timing evaluation process is made to end.

On the other hand, in a case that an affirmative determination is obtained at step S200, the process goes to step S220 to execute a particular sign evaluation process. In the particular sign evaluation process, the evaluation depending on the particular sign following the operation object word is executed. In a case of the vibrato sing VS, besides the evaluation of the operation timing of the operation object word, the operation timing of the vibrato operation is also evaluated. With respect to the operation object word, the accuracy is determined in a similar way to the normal evaluation process. With respect to the vibrato operation, the accuracy of each operation timing is determined based on a disparity amount between the operation timing at each turn in the vibrato operation and the corresponding aim timing T. Then, the accuracy which is obtained by averaging all of the obtained accuracies may be the evaluation obtained by the timing evaluation process.

In a case of the prolonged-sound sign PS, as well as the evaluation of the operation timing of the operation object word, the prolonged-sound operation is also evaluated. With respect to the operation object word, the accuracy is determined in a similar way to the normal evaluation process. With respect to the prolonged-sound operation, by setting the moment when the operation of holding down is stopped as the operation timing, and setting the timing when the operation of holding down should be stopped as the aim timing T, a disparity amount between the operation timing and the aim timing T is calculated, and based on the disparity amount the accuracy of the prolonged-sound operation is determined. Then, the accuracy which is obtained by averaging all of the determined accuracies may be the evaluation by the timing evaluation process. After the particular sign evaluation process, the timing evaluation process is made to end.

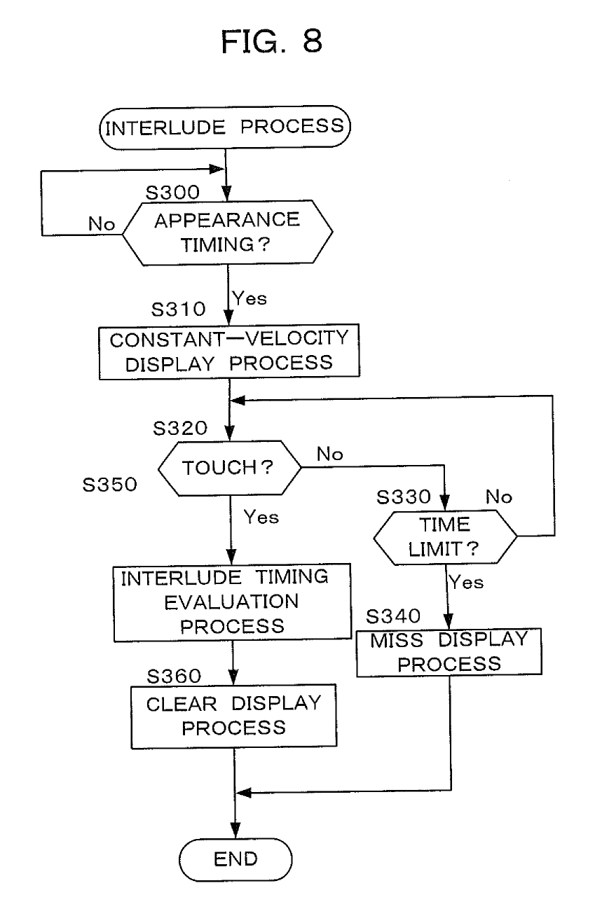

The interlude process will be described by following a flow chart shown in FIG. 8. The interlude process is executed for each note mark NM set in the game data GD. The interlude process for each note mark NM is controlled by the game control portion 14 as a constant-velocity sign control portion. Hereinafter, the note mark NM which is an operation object in the interlude process is referred to as the “operation note mark NM”. First, at step S300, referring to the tune timer, it is determined whether the present time is the appearance timing of the operation note mark NM or not. The appearance timing may be obtained by calculating the time it takes to move from the appearance point AP to the process line PL based on the moving velocity of the operation note mark NM and the distance between the appearance point AP and the process line PL, and back calculating from the aim timing T. At step S300, in a case that a negative determination is obtained, the operation of step S300 is repeated. In a case that an affirmative determination is obtained, the process goes to step S310 to execute an constant-velocity display process. In the constant-velocity display process, the operation note mark NM is made appear at the appearance point AP of the corresponding display row SR, and is moved on the game image GI at the moving velocity.

At step S320, it is determined whether the touch operation has been performed by the player. At step S320, a negative determination is obtained, the process goes to step S330 to determine whether the time limit has come. The time limit in the interlude process is a limit of time when the touch operation can be accepted for the operation note mark NM. For example, the time limit may be set to 0.5 seconds after the moment when the operation note mark NM passes through the process line PL, that is, 0.5 seconds after the aim timing T. At step S330, when a negative determination is obtained, the process returns to step S320 to maintain the mode of waiting touch operation. At step S330, when an affirmative operation is obtained, the process goes to step S340 to execute a miss display process. In the miss display process in the interlude process, as mentioned above, the operation note mark NM is displayed in the miss display mode 6.

When the operation note mark NM in the operation miss mode 6 disappears from the game image GI, the interlude process for the operation note mark NM is made to end. Before the note mark NM in the operation miss mode 6 disappears from the game image GI, if a safe touch operation is performed by the player, a safe process is executed. After the safe process is completed, the interlude process is made to end. The safe touch operation and the safe process will be described later.

On the other hand, when an affirmative determination is obtained at step S320, the process goes to step S350 to execute an interlude timing evaluation process. In the interlude timing evaluation process, in a similar way to the timing evaluation process in the game process, the accuracy of operation timing is determined based on a disparity amount between the operation timing when the touch operation has been performed by the player and the aim timing T of the operation note mark NM. Then, the smaller the disparity amount between the operation timing and the aim timing T is, the higher the accuracy is evaluated, and the bigger the disparity amount is, the lower the accuracy is evaluated. In addition, it is also determined which the operation timing is earlier or later than the aim timing T. The timing of input operation is specified sequentially based on the input operation data which is recorded sequentially in response to an input operation by the operation input portion 11.

When the timing evaluation is determined, a clear display process is executed at step S360. In the clear display process, a process for displaying the operation note mark NM in the clear display mode is executed based on the timing evaluation which was obtained for the operation note mark NM at step S350. For example, in a case that the accuracy satisfies a predetermined criterion, the operation note mark NM is displayed in the accuracy mode 4, and in a case that the accuracy does not satisfy the predetermined criterion, the operation note mark NM is displayed in the inaccuracy mode 5. Moreover, in the case of the inaccuracy mode 5, when the operation timing is earlier than the aim timing T, the operation note mark NM is tilted to the left to be displayed, and when the operation timing is later than the aim timing T, the operation note mark NM is tilted to the right to be displayed. When the clear display process of step S260 is completed, the interlude process is made to end.

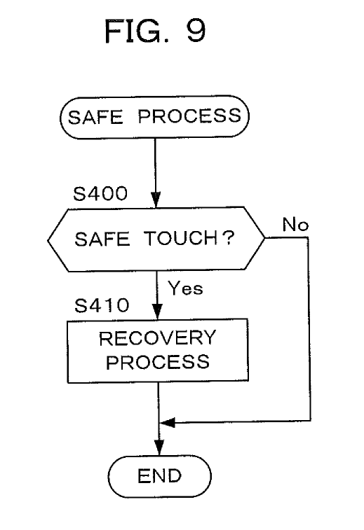

The safe process will be described by following a flow chart shown in FIG. 9. First, at step S400, it is determined whether the safe touch operation has been performed by the player or not. Before disappearing from the game image GI, If the note mark NM or the operation object word moving in the miss mode 3, 6 is directly touched, it is determined that the safe touch operation has been performed. When an affirmative determination is obtained at step S400, a recovery process is executed. In the recovery process, the note mark NM or the operation object word shown in the miss mode 3, 6 is changed into a recovery mode. For example, the note mark or the operation object word may be moved to the top of the game image GI like the clear display, and also a predetermined recovery points are added to the score of the player. At step S400, when a negative determination is obtained, or after the recovery process is completed, the safe process is made to end.

In a case that the tune data of the tune to be reproduced is the same as the tune data which is expected for the game data GD, the mentioned processes can be applied. However, even if the tune is the same, there are different tune data having a different arrangement or having a gap from an original tune data because of its encode. A process for enabling to handle the tune data except the tune data which is expected for the game data GD, will be described. Hereinafter, the tune data which is expected for the game data GD is referred to as a criterion tune data X, and the tune data which is actually used in the game and which is different in arrangement from the tune data X is referred to as the using tune data Y. First, with respect to the criterion tune data X, a sound analysis is executed. in the sound analysis, the characteristics of the tune are analyzed based on the average sound pressure, the sound pressure shift, and the characteristics of wave length. Thereby, the criterion tune data X is divided into components corresponding to the characteristics of the tune. A well-known method may be applied to the sound analysis in the present invention.

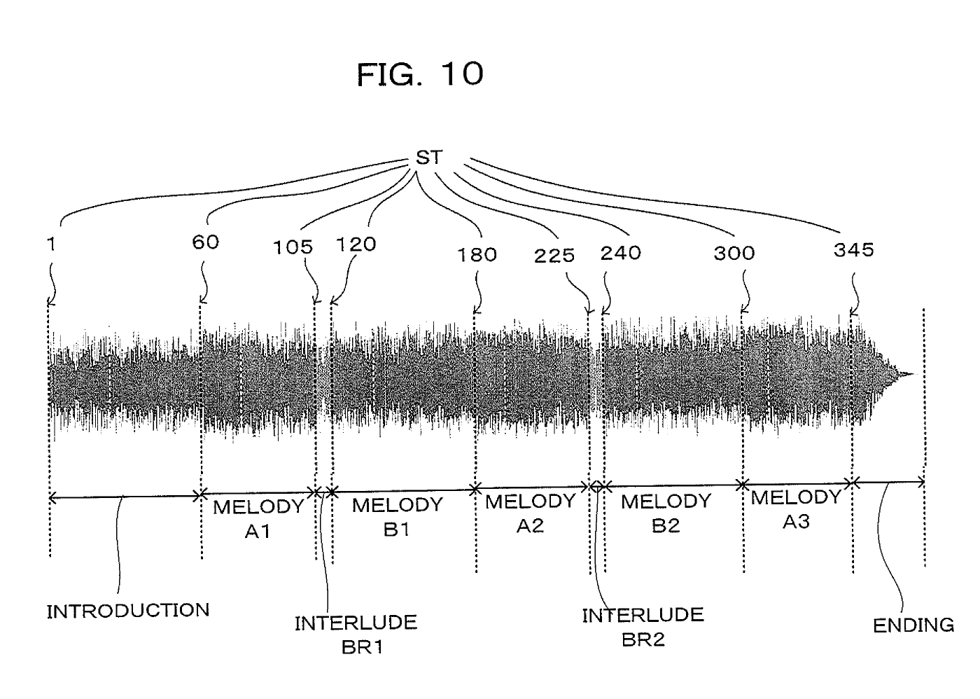

A case that the analysis result as shown in FIG. 10 is obtained by the sound analysis about the criterion tune data X, will be described. In the case shown in FIG. 10, it is shown that the criterion tune data X is consisted of nine components that are an introduction part, a melody A1, an interlude BR1, a melody B1, a melody A2, an interlude BR2, a melody B2, a melody A3, and a ending part. The numeral shown for each component is a start timing when, after the reproduction of the criterion tune data X being started, the performance of each component should be started, the start timing being represented by seconds. All of the melody A1, the melody A2 and the melody A3 have the characteristics as a melody A, but the start timings ST thereof are different from each other, and both of the melody B1 and the melody B2 have the characteristics as a melody B, but the start timings ST thereof are different from each other.

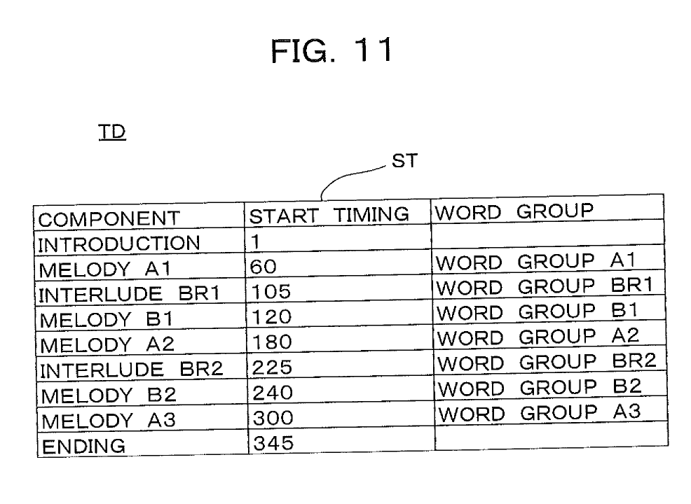

Then, criterion-tune characteristics data TD in which, for each component, the start timing ST thereof and the word group included therein are associated with each other is generated as a table shown in FIG. 11, and is stored in, for example, the tune characteristics data storage portion in the data storage portion 13. In each column of component in the table, the characteristics of wave form and sound pressure of each component are set. For example, in the tune characteristics data TD, the melody A1 part indicates that, when sixty seconds passes after the reproduction of criterion tune data X starts, the performance is started and the word included in the word group A1 is sung. The criterion-tune characteristics data TD may be generated by executing the sound analysis of the criterion tune data X in the game machine G, or may be obtained from the other construction. In the embodiment that the criterion-tune characteristics data TD is obtained from the other construction, for example, a case of obtaining the data by downloading from a predetermined site and a case of obtaining the data from a storage medium where the criterion-tune characteristics data TD is stored are included.

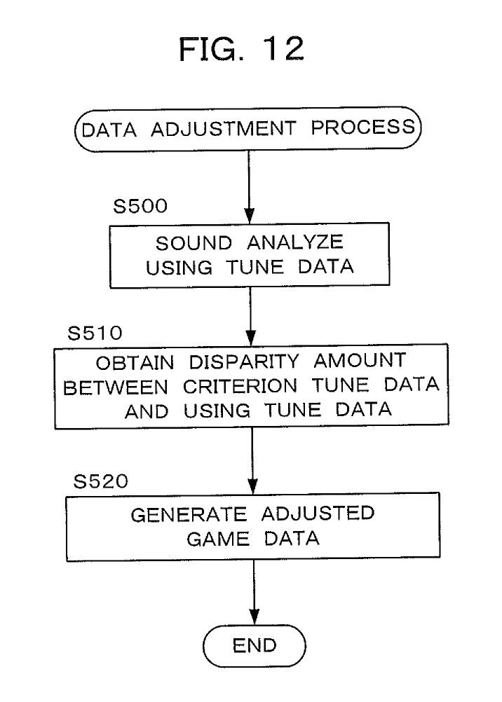

Then, in order to make the game data GD adjust to the using tune data Y, in the start process (step S100) of the game process, the data adjustment process for making the game data GD adjust to the using tune data Y is executed. The data adjustment process will be described by following a flow chart shown in FIG. 12. First, at step S500, the using tune data Y is sound analyzed as shown in FIG. 10 to specify the start timing ST of each component shown in FIG. 11. Then, the using-tune characteristics data in which each component is associated with the start timing thereof in the using tune is generated. Next, at step S510, the criterion-tune characteristics data TD is compared with the using-tune characteristics data generated, and a disparity amount between the criterion tune data X and the using tune data Y in the start timing ST for each component is obtained.

Then, at step S520, adjusted game data GD′ which is adjusted for the using tune data Y is generated by adjusting the aim timing T of each word W in the game data GD depending on the obtained disparity amount of each component. In this way, when the using dune data Y is different from the criterion tune data X, the adjusted game data GD′ in which the aim timings T is adjusted for the using tune data Y is generated by the data adjustment process. Then, the game process is executed based on the adjusted game data GD′ which has been generated. Thereby, it is possible to provide a game suitable for the arrangement of the using tune data Y.

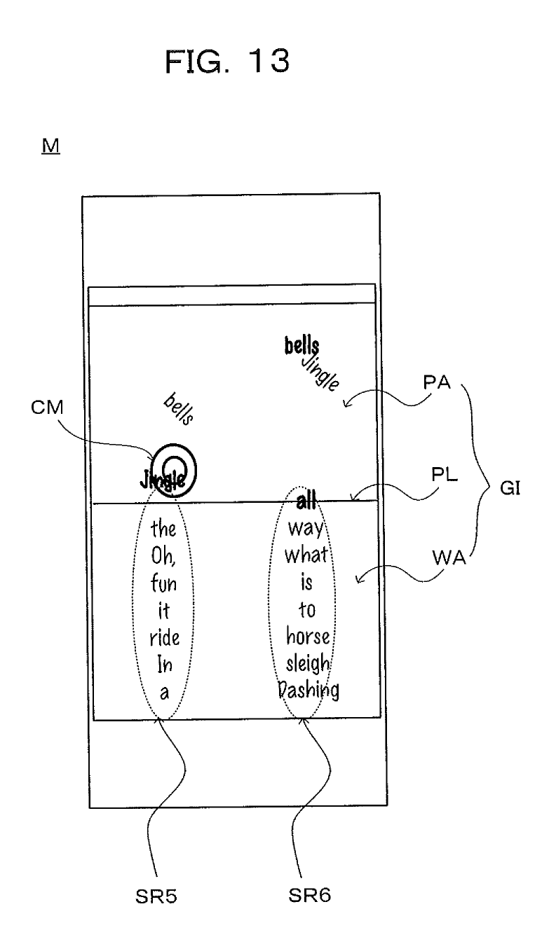

The present invention is not limited to the above embodiment, and may be realized in various kinds of embodiments. For example, without the operation area OA corresponding to each display row SR, when anywhere on the monitor M is touched, it may be determined that the touch operation has been performed. In the game image GI, the word area WA and the play result area PA may be arranged in the horizontal direction, and the display rows SR may extend in the horizontal direction. Moreover, the number of display rows SR to be displayed in the game image GI is not limited to three. As shown in FIG. 13, two display rows, the display row SR5 and the display row SR6, may be displayed. In a case that the accuracy is high, as shown in FIG. 13, an accuracy mark CM may be displayed momentarily. The accuracy mode 1, the inaccuracy mode 2, and the miss operation mode 3 which are displayed in the play result area PA may be set so that they have different from each other in a color, a size, a shape and the like, in order to be visually distinguished from each other.

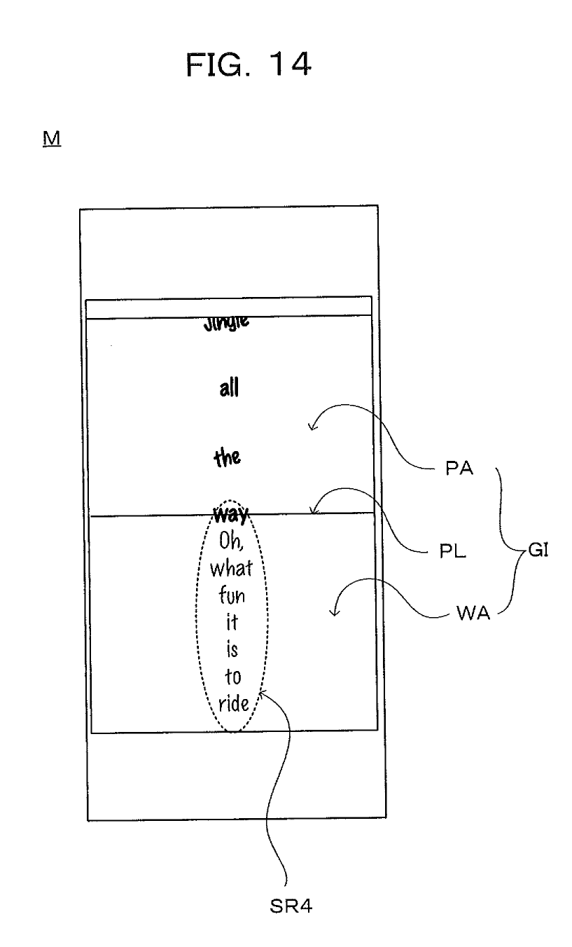

Moreover, the display row SR may be one display row SR4 as shown in FIG. 14. In this case, since the words W in the display row SR4 are arranged in the order set in the game data GD, the column for the display row SR is not necessary. It is not necessary that the appearance point AP in the interlude game is fixed. In this case, the game system may be designed such that the appearance point AP in the game image GI is set for each note mark NM in the game data GD, and in the interlude process for each note mark NM, the appearance timing of each note mark NM is determined based on the distance from the appearance point AP set for the note mark NM up to the process line P and the moving velocity.

In addition, in a case that the tune to be reproduced is a choral music composed by a plurality of parts, the game machine G of the present invention can also provide such a game (hereinafter referred to as “the multi mode game 1”) where the display row SR for each of the parts is displayed and the input operation for each part is required to a player. With respect to the process for realizing the multi mode game 1, only processes different from the above embodiment will be described. For example, in a case of the choral music B which is composed of two parts P1, P2, the game data GD1, GD2 for the parts P1, P2 are stored in the game data storage portion 13b respectively, and are referred in the game. In the game data GD1, GD2, the aim timing T corresponding to the word W included in the parts P1, P2 are set respectively. In the game data storage portion 13b, the game data GD1 and the game data GD2 are associated with each other as multi mode data for realizing the multi mode game 1. For the interlude game, the note mark NM may be set in either the game data GD1 or the game data GD2.

When the multi mode game 1 is started, on the monitor M, a game image GI1 and a game image GI2 are displayed side by side. In the game image GI1, the display row SR composed of the words W included in the part P1 is displayed, and in the game image GI2, the display row SR composed of the words W included in the part P2 is displayed. In the processes from step S105 to step S145 in the game process, the processes similar to the processes of game data GD corresponding to the game image GI where one display row SR4 is displayed, are executed with the progress of the choral music B, with respect to each of the game data GD1 corresponding to the game image GI1 and the game data GD2 corresponding to the game image GI2. In the interlude process at step S150, only the game data GD1, GD2 where the note marks NM are set is used. The plurality of parts composing the multi mode game 1 may be plural chorus parts, a main vocal and back chorus, or the like.

Moreover, the game machine G of the present invention also provides such a game (hereinafter referred to as “the multi mode game 2”) where input operations based on a rhythm of accompaniment are also required as well as input operations based on the lyrics. With respect to the process for realizing the multi mode game 2, only the processes different from the above mentioned embodiment will be described using as an example, the lyrics and accompaniment in the above mentioned embodiment. In this embodiment, as the game based on a rhythm of accompaniment, the interlude game in the mentioned embodiment is provided. First, in the game data storage portion 13b, accompaniment data is stored as well as the game data GD. In the accompaniment data, the note mark NM and the aim timing T are set. The aim timing T is an arrival timing when the note mark NM should reach the process line P. It is desired that the arrival timing of the note mark NM is suitable for the rhythm of a predetermined instrument in the accompaniment.

When the multi mode game 2 is started, the game process is executed, and the game image GI and the game image GI′ are displayed side by side on the monitor M. In the game image GI′, a game based on the rhythm of accompaniment is executed. For the game image GI, the processes of step S105 to S150 and S160 are executed. With respect to the game image GI′, for each of the note marks NM set in the accompaniment data, processes similar to the interlude process are executed by the game control portion 14 functioning as a constant-velocity-sign control portion and an operation evaluation portion. Thereby, the multi mode game is provide, where, in the game image GI, input operations are required with the progress of the lyrics. In the game image GI′, input operations are required with the rhythm of accompaniment. It does not matter how many numbers of display rows SR are displayed in the game image GI.

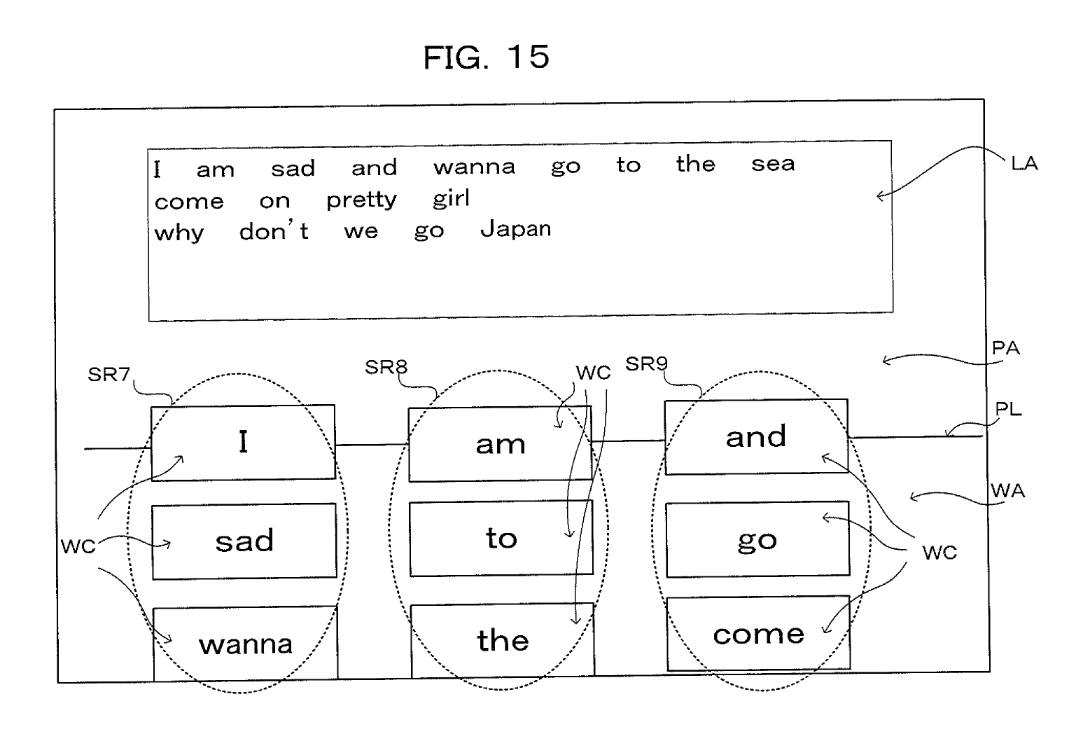

The game image GI of the present invention may be designed as the game image shown in FIGS. 15 to 17. In the same way as the game image GI, in the word area WA of the game image GI, three display rows SR7 to SR9 are displayed. For each of the display rows SR, three word cards WC are arranged. Each of the word cards WC shows a word W. In this game image GI, the method of displaying the word W in the display row SR in the above mentioned embodiment may be applied to the method of displaying the word cards WC in each display row SR. On the other hand, in the play result area PA of this game image GI, the lyrics to be sung are displayed in a lyrics area LA, and this embodiment is designed such that the display mode in the play result area PA is different from the mentioned embodiment.

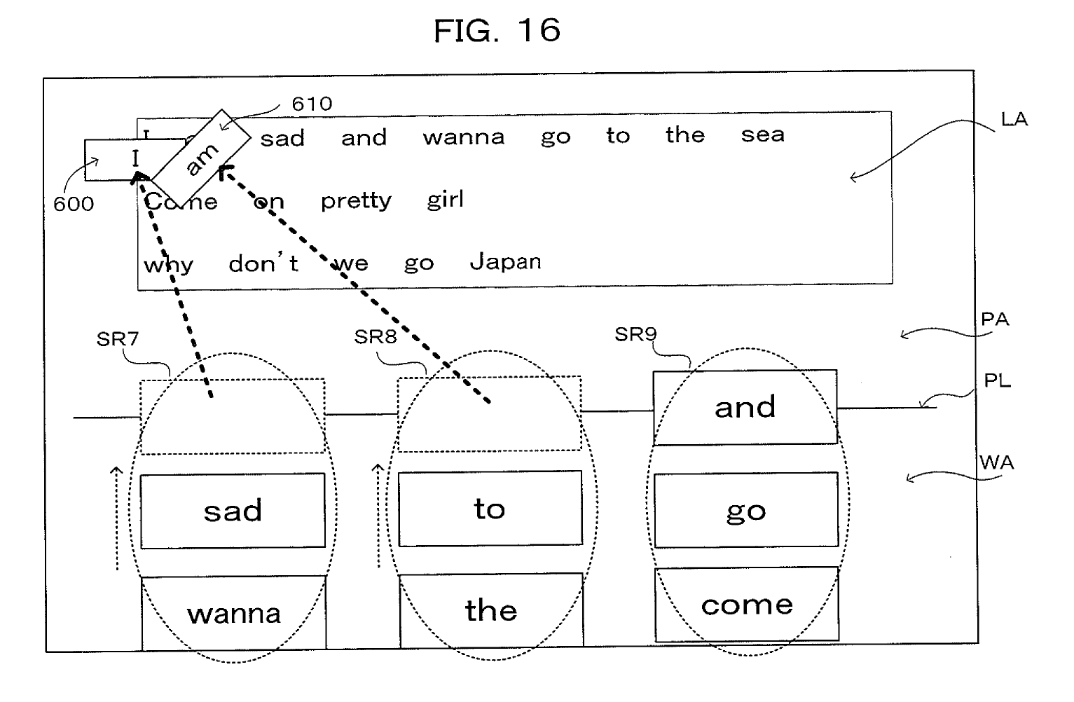

In this game image GI, the game system is designed such that each time the touch operation is performed, the word card WC is moved and bonded to the corresponding word in the lyrics area LA, as shown in FIG. 16. The word card WC which is bonded to the lyrics area LA is shown in an accuracy mode 600 in a case that the accuracy as the evaluation of operation timing satisfies a predetermined criterion, and is shown in an inaccuracy mode 610 in a case that the accuracy does not satisfy the predetermined criterion. In the same way as the above mentioned embodiment, the inaccuracy mode 610 is designed such that the bigger the disparity amount between the operation timing and the aim timing T is, the bigger the tilt angle of the word card WC is. In FIG. 16, the word card “I” is being shown in the lyrics area LA in the accuracy mode 600, and the word card “am” is being shown in the Lyrics area LA in the inaccuracy mode 610.

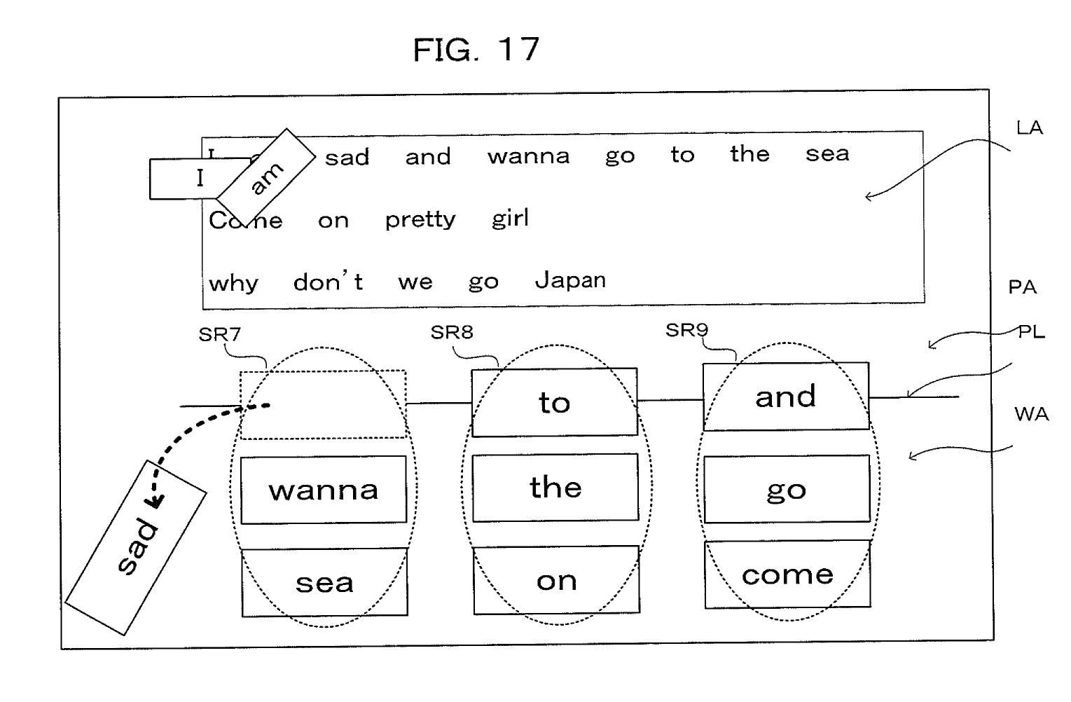

When the time limit of the operation object word W has come, as the miss operation mode 620, it is shown that the word card WC of the operation object word drops down from the display row SR, as shown in FIG. 17. In FIG. 17, the operation object word “happy” is being shown in the miss operation mode 620. The control of lyrics information displayed in the lyrics area LA may be realized by a lyrics display control portion which is provided to the game control 14, the lyrics display control portion showing a predetermined amount of lyrics from a part being sung at the moment referring to the time count by the tune timer.

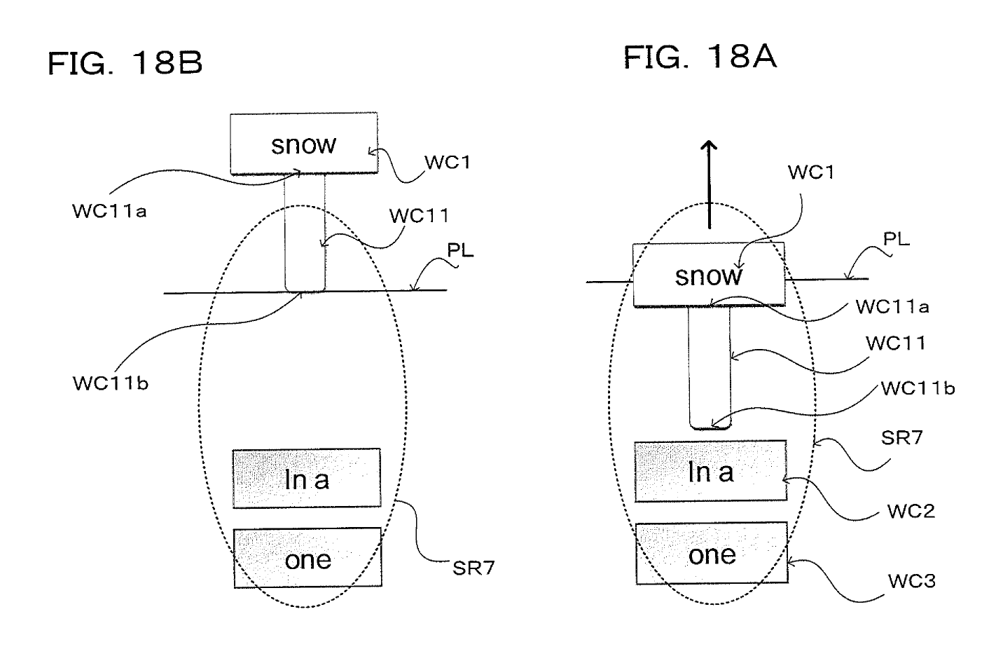

The game system may be designed such that in the game image GI shown in FIG. 15, a mark indicating the particular sign is also displayed in the game image GI. Using FIGS. 18A and 18B, a case will be described, that the display row SR7 is composed of the three word cards WC1 to WC3: “snow”; “In a”; and “one”, and the prolonged-sound sign PS is set following the word “snow” in the game data GD. In this case, the prolonged-sound mark WC11 indicating the prolonged-sound sign PS is added to the word card WC1 of the corresponding word “snow”. The prolonged-sound mark WC11 has a rectangular shape with a predetermined length, and is shown in a state that the top portion WC11a is bonded to the word card WC11. The word card WC1 on the process line PL starts to move upward leaving the process line PL at the corresponding aim timing T, as shown in FIG. 18.

Then, as shown in FIG. 18B, the word card WC1 moves with the prolonged-sound mark WC11 in such a way that the bottom portion WC11b of the prolonged-sound mark WC11 passed through the process line PL at the aim timing T of the prolonged-sound sign PS. Thereby, a player performs the prolonged-sound operation, that is, the operation of holding his/her finger or pen down on the monitor M, by recognizing the prolonged-sound mark WC11, and the player can regard the moment when the bottom portion WC11b of the prolonged-sound mark WC11 passes through the process line PL as a timing to release the prolonged-sound operation, that is a timing to leave the finger or pen from the monitor M. The length in the vertical direction of the prolonged-sound mark WC11 may be constant, or may be set depending on how long the player is required to perform the prolonged-sound operation.

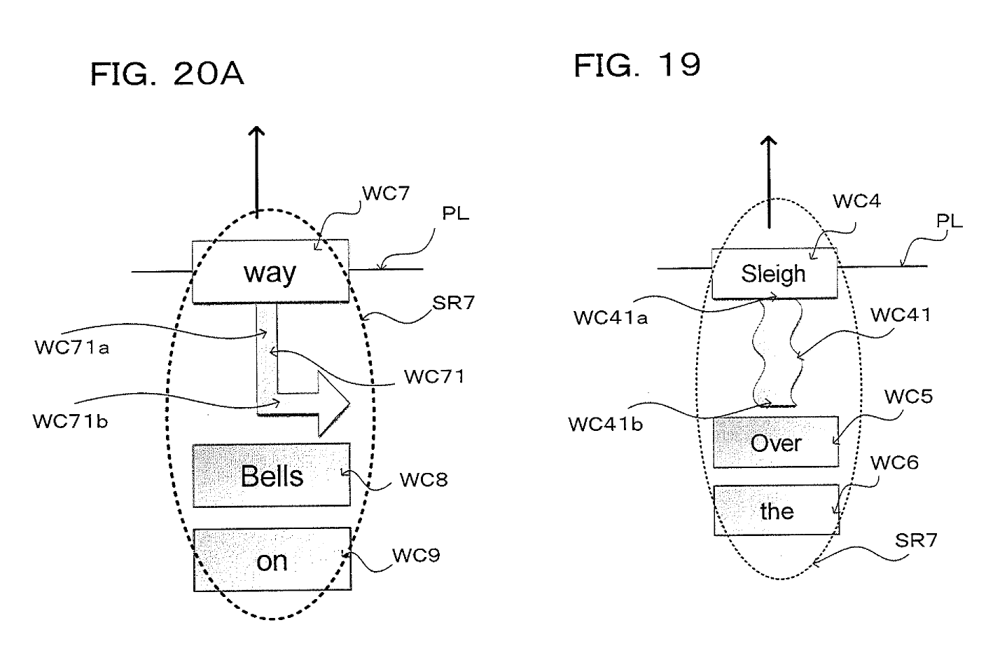

Next, using FIG. 19, a state will be described, that the display row SR7 is composed of three word cards WC4 to WC6:“Sleigh”, “Over”, and “the”, and a vibrato sing VS is set following the word “sleigh” in the game data GD. In this case, the vibrato mark WC41 indicating the vibrato sign VS is added to the word card WC4 of the corresponding word “Sleigh”. The vibrato mark WC41 has a wave shape with a predetermined length, and is shown in such a way that the top portion WC41a is bonded to the word card WC4. As shown in FIG. 19, at the corresponding aim timing T, the word card WC4 arranged on the process line PL starts to move upward leaving the process line PL.

Then, in the similar manner to the prolonged-sound mark WC11, the word card WC4 moves with the vibrato mark WC41 in such a way that, at the aim timing T of the vibrato sign VS, the bottom portion WC41b of the vibrato mark WC41 passes through the process lint PL. Thereby, a player performs the vibrato operation, that is, the operation of reciprocating his/her finger or pen on the monitor by recognizing the vibrato mark WC41, and the player can regard the moment when the bottom portion WC41b of the vibrato mark WC41 passes through the process line PL as a timing to stop the vibrato operation, that is, a stop timing of the reciprocation. The length in the vertical direction of the vibrato mark WC41 may be constant, or may be set depending on how long the player is required to perform the vibrato operation.

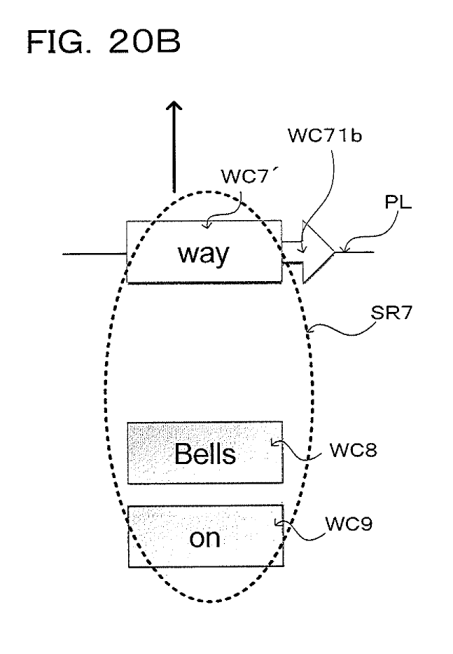

Further, as the particular sign, a bounce sign may be also set for a case that the ending of a word W to be sung is bounced. In the game data GD, the bounce sign is set following the corresponding word, and the timing of requiring a player to perform a bounce operation is set to the aim timing T of the bounce sign. The bounce operation is the operation of snapping a finger or pen on the monitor. For example, using FIGS. 20A and 20B, a case will be described that the word cards WC7, WC8 and WC9 of the words “way”, “Bells” and “on” are arranged in the display row SR7, and the bounce sign is set to the word “way”. As shown in FIG. 20A, the bounce sign is added, as a bounce mark WC71, to the word card WC7 of the corresponding word “way”. The bounce mark WC71 comprises a prolonged-sound portion WC71a having a predetermined length and a bounce portion WC71b.

The word card WC7 of “way” starts moving upward from the process lint PL at the aim timing T for the “way”, and moves upward with the prolonged-sound portion WC72a and the bounce portion WC71b in such a way that the bounce portion WC71b reaches the process line PL at the aim timing T of the bounce sign. Thereby, when operating the touch operation for the word “way” being placed on the process line PL, continuously a player holds his/her finger or pen down on the monitor, and the player can recognize the timing to operate the bounce operation at the moment when the bounce portion WC71b reaches the process line PL.

The length of the prolonged-sound portion WC71a may be set depending on a difference between the aim timing T of the corresponding word “way” and the aim timing T of the bounce sign. In a case that the ending of the word should be bounced following the word, the aim timing T of the bounce sign may be the same as the aim timing T of the corresponding word. In this case, as shown in FIG. 20B, without the prolonged-sound portion WC71a, the bounce portion WC71b is displayed in such a way that the bounce portion WC71b is placed on the process lint PL at the same timing as the corresponding word “way”.

In addition, in a case of Japanese lyrics, one letter of hiragana may be regarded as one word W, or one letter of kanji may be regarded as one word W.

### EXPLANATION OF REFERENCE NUMBERS

10 A display portion
11 An operation input portion
12 A sound output portion
14a A display control portion
14aa A a letter-string line generating portion
14ab A letter-string line display control portion
14b An operation evaluation portion
14c An operation object specifying portion
W A word (a letter string)
SR A display row (a letter-string line)

1. A game machine comprising:
a display portion which displays a game image;
a sound output portion which reproduces and outputs a predetermined tune;
an operation input portion which accepts an input operation by a player;
a display control portion which arranges and displays in the game image, a plurality of letter strings in such a way that a plurality of letter-string lines are formed, the plurality of letter strings being obtained by dividing at least one part of lyrics of the tune;
an operation object specifying portion which specifies the letter string of operation object within the plurality of letter strings; and
an operation evaluation portion which evaluates the operation by the player to the letter string of operation object, wherein
the game machine further comprises
a game data storage portion which stores game data where each of the plurality of letter strings is correlated to a timing in the tune for the letter string to be sung,
the display control portion comprises:
a letter-string line generating portion which generates the plurality of letter-string lines by allotting each of the letter strings to any one of the letter-string lines in such a way that, in each of the letter-string line, the letter string to be sung relatively early is positioned relatively forward; and
a letter-string line display control portion which displays in the game image, the plurality of letter-string lines generated, and updates sequentially a display of each of the letter-string lines with a progress of the tune being reproduced by the sound output portion, such that, for each letter-string line, the letter string to be sung first in the letter-string line is displayed at a top of the letter-string line,
the operation object specifying portion sequentially specifies, each time when a timing for the word to be sung stored in the game data comes in the progress of the tune being reproduced, the letter string correlated to the timing as the operation object, and
the operation evaluation portion evaluates the operation by the player based on a timing in the tune of a moment when the input operation is performed to the operation input portion by the player and the timing to be sung correlated to the letter string which has been specified by the operation object specifying portion.

2. The game machine of claim 1, wherein
the letter-string line display control portion displays a predetermined number of letter strings in an order that the letter strings are arranged in each letter-string line and displays on one criterion line in the game image, the letter strings each of which is displayed at the top of corresponding letter-string line.

3. The game machine of claim 1, wherein
the operation input portion has a line operation input portion provided for each letter-string line, and the operation evaluation portion, when the input operation has been performed to the line operation input portion corresponding to the letter string of the operation object, evaluates the input operation.

4. The game machine of claim 3, wherein
the operation input portion accepts the input operation by a touch panel sensor which is unified to the display portion, and the line operation input portion is an area corresponding to each letter-string lines in the display portion.

5. A game machine comprising:
a display portion which displays a game image;
a sound output portion which reproduces and outputs a predetermined tune;
an operation input portion which accepts an input operation by a player;
a display control portion which arranges and displays in the game image, a plurality of letter strings in such a way that one letter-string line is formed, the plurality of letter strings being obtained by dividing at least one part of lyrics of the tune;
an operation object specifying portion which
specifies the letter string of operation object within the plurality of letter strings; and
an operation evaluation portion which evaluates the operation by the player to the letter string of operation object, wherein
the game machine further comprises
a game data storage portion which stores game data where each of the plurality of letter strings is correlated to a timing in the tune for the letter string to be sung,
the display control portion comprises:
a letter-string line generating portion which generates the plurality of letter-string line by arranging each of the string letters in an order for the string letter to be sung; and
a letter-string line display control portion which displays in the game image, the letter-string line generated, and updates sequentially a display of each of the letter-string lines with a progress of the tune being reproduced by the sound output portion, such that the letter string to be sung is displayed sequentially at a top of the letter-string line,
the operation object specifying portion sequentially specifies, each time when a timing for the word to be sung stored in the game data comes in the progress of the tune being reproduced, the letter string correlated to the timing as the operation object, and
the operation evaluation portion evaluates the operation by the player based on a timing in the tune of the moment when the input operation is performed to the operation input portion by the player and the timing to be sung correlated to the letter string which has been specified by the operation object specifying portion.

6. The game machine of claim 5, wherein
the letter-string line display control portion displays a predetermined number of letter strings in an order that the letter strings are arranged in the letter-string line and displays on one criterion line in the game image, the letter string which is displayed at the top of the letter-string line.

7. The game machine of claim 2, wherein
the string-letter line display control portion removes the letter string of operation object from the letter-string line, when the input operation is performed to the letter string of operation object, and in the letter-string line, displays from the top thereof, the predetermined number of string letters following the letter string of operation object.

8. The game machine of claim 7, wherein
the letter-string line display control portion removes the letter string of operation object from the letter-string line by separating the letter string from the letter-string line, and
the operation evaluation portion changes, depending on the evaluation to the player, a display mode of the letter string of operation object which has been separated from the letter string line.

9. The game machine of claim 8, wherein
the operation evaluation portion displays the letter string separated in the display mode depending on a disparity amount between the timing to be sung correlated to the letter string of operation object and the timing in the tune of a moment when the input operation has been performed.

10. The game machine of claim 1, wherein
each of a plurality of constant-velocity signs and a timing in the tune of a moment when the constant-velocity sign should reach a predetermined operation position in the game image are correlated to each other and further stored in the game data,
the display control portion further comprises a constant-velocity sign control portion which makes the constant-velocity sign appear at a predetermined appearance point in the game image and controls a move of the constant-velocity sign such that the constant-velocity sign moves in the game image at a predetermined velocity to reach the predetermined operation position at the corresponding timing in the tune, and
the operation evaluation portion evaluates the operation by the player based on the timing in the tune of a moment when the input operation has been performed to the constant-velocity sign and the timing in the tune correlated to the constant-velocity sign.

11. The game machine of claim 1, wherein
when a particular sign to require a particular operation and a timing in the tune for the particular sign are correlated to each other following the letter string in the game data, the operation evaluation portion evaluates the particular operation based on a timing in the tune of a moment when the particular operation has been performed and a timing in the tune correlated to the particular sign, and determines an evaluation for the letter string by using the evaluation for the operation to the letter string by the player and the evaluation for the particular operation.

12. The game machine of claim 1, wherein
the game data storage portion further stores tune characteristics information, in which each of a plurality of components and a start timing in the tune that the component is started are correlated to each other, the components being obtained by dividing, based on sound characteristics, tune data of the tune corresponding to the game data,
the game machine further comprises:
a using tune analysis portion which sound analyzes using tune data which is tune data of a tune to be used, and obtains a start timing of each of the components for the using tune data, and
a data adjustment portion which generates adjusted game data by adjusting the timings to be sung correlated in the game data to the letter strings included in each of the components, based on the start timing of each of the components in the tune characteristics information and the start timing of each of the components in the using tune data, and
the operation evaluation portion evaluates the operation by the player based on the adjusted game data.

13. The game machine of claim 5, wherein
the tune is a choral music which has plural parts,
the game data storage portion stores the game data for each of the parts, in which each of the letter strings which are obtained by dividing the lyrics in the corresponding part and a timing for the letter string to be sung are correlated to each other,
the letter-string line generating portion generates the letter string line corresponding to each of the parts by arranging each letter string for each part in an order for the letter string to be sung,
the letter-string line display control portion updates sequentially a display of the letter-string line corresponding to each of the parts,
the operation object specifying portion, each time when the timing to be sung set in the game data for each part has come, specifies as the operation object, the at least one letter string correlated to the timing, and
the operation evaluation portion evaluates, with respect to each letter string specified as the operation object, the operation by the player based on the timing that the input operation has been performed and the timing to be sung.

14. The game machine of claim 1, wherein
the game data storage portion stores, with respect to the tune, besides the game data, constant-velocity game data in which each of a plurality of constant-velocity signs is correlated to a timing in the tune that the constant-velocity sign should reach a predetermined operation position in the game image,
the display control portion further comprises, besides the letter-string line generating portion and the letter-string line display control portion, a constant-velocity sign control portion which controls a move of the constant-velocity sign in such a way that the constant-velocity sign is made to appear at a predetermined appearance point in the game image when the tune is reproduced, and made to move in the game image at a predetermined velocity such that the constant-velocity sign reaches the predetermined operation portion at the timing in the tune correlated to the sign, and,
the operation evaluation portion evaluates the operation by the player, besides the evaluation for the operation by the player to the letter string specified as the operation object, based on a timing in the tune of a moment when the input operation has been performed to the constant-velocity sign and the timing in the tune correlated to the sign.

15. A storage medium for storing a game program which controls a computer of a game machine, the game machine comprising:
a display portion which displays a game image;
a sound output portion which reproduces and outputs a predetermined tune;
an operation input portion which accepts an input operation by a player;
a display control portion which arranges and displays in the game image, a plurality of letter strings in such a way that a plurality of letter-string lines are formed, the plurality of letter strings being obtained by dividing at least one part of lyrics of the tune;
an operation object specifying portion which specifies the letter string of operation object within the plurality of letter strings;
an operation evaluation portion which evaluates the operation by the player to the letter string of operation object; and
a game data storage portion which stores game data where each of the plurality of letter strings is correlated to a timing in the tune for the letter string to be sung, wherein
the game program controls the computer to function as
the display control portion which comprises:
a letter-string line generating portion which generates the plurality of letter-string lines by allotting each of the letter strings to any one of the letter-string lines in such a way that, in each of the letter-string line, the letter string to be sung relatively early is positioned relatively forward; and
a letter-string line display control portion which displays in the game image, the plurality of letter-string lines generated, and updates sequentially a display of each of the letter-string lines with a progress of the tune being reproduced by the sound output portion, such that, for each letter-string line, the letter string to be sung first in the letter-string line is displayed at a top of the letter-string line,
the operation object specify portion which sequentially specifies, each time when a timing for the word to be sung stored in the game data comes in the progress of the tune being reproduced, the letter string correlated to the timing as the operation object, and
the operation evaluation portion which evaluates the operation by the player based on a timing in the tune of a moment when the input operation is performed to the operation input portion by the player and the timing to be sung correlated to the letter string which has been specified by the operation object specifying portion.

16. A storage medium storing a game program which controls a computer of a game machine, the game machine comprising:
a display portion which displays a game image;
a sound output portion which reproduces and outputs a predetermined tune;
an operation input portion which accepts an input operation by a player;
a display control portion which arranges and displays in the game image, a plurality of letter strings in such a way that one letter-string line is formed, the plurality of letter strings being obtained by dividing at least one part of lyrics of the tune;
an operation object specifying portion which specifies the letter string of operation object within the plurality of letter strings;
an operation evaluation portion which evaluates the operation by the player to the letter string of operation object; and
a game data storage portion which stores game data where each of the plurality of letter strings is correlated to a timing in the tune for the letter string to be sung, wherein
the game program controls the computer to function as
the display control portion which comprises:
a letter-string line generating portion which generates the plurality of letter-string line by arranging each of the string letters in an order for the string letter to be sung; and
a letter-string line display control portion which displays in the game image, the letter-string line generated, and updates sequentially a display of each of the letter-string lines with a progress of the tune being reproduced by the sound output portion, such that the letter string to be sung is displayed sequentially at a top of the letter-string line,
the operation object specifying portion which sequentially specifies, each time when a timing for the word to be sung stored in the game data comes in the progress of the tune being reproduced, the letter string correlated to the timing as the operation object, and
the operation evaluation portion which evaluates the operation by the player based on a timing in the tune of the moment when the input operation is performed to the operation input portion by the player and the timing to be sung correlated to the letter string which has been specified by the operation object specifying portion.
